(19) United States
(12) Patent Application Publication
(10) Pub. No.: US 2014/0278669 A1
(43) Pub. Date: Sep. 18, 2014

(54) Coordination of Brokered Engagements

(71) Applicant: Roy Schoenberg, Boston, MA (US)

(72) Inventor: Roy Schoenberg, Boston, MA (US)

(21) Appl. No.: 13/799,927

(22) Filed: Mar. 13, 2013

(51) Int. Cl. G06Q 10/10

(52) U.S. Cl. CPC G06Q 10/1095
USPC 705/7.19

(57) ABSTRACT

A computer-implemented method includes receiving, from a brokerage system, a request for a virtual consultation with a service provider, with the requested consultation being one or more of an online consultation or a telephonic consultation; accessing, by a practice management system, a schedule indicative of one or more office appointments of the requested service provider, with the practice management system being remote from the brokerage system; determining, by the practice management system based on the accessed schedule, a time slot in which the requested service provider is available for the requested virtual consultation; and updating, by the practice management system, the schedule with an appointment for the virtual consultation to occur during the determined time slot.

### BACKGROUND

The present disclosure is directed to coordinating brokered engagements for connecting consumers with service providers.

Systems have been developed to connect consumers and their providers over the Internet and the World Wide Web. Some systems use e-mail messaging and web-based forms to increase the level of connectivity between a member of a health plan and his assigned health care provider. The consumer sends an e-mail or goes to a website that generates and sends a message (typically an e-mail or an e-mail type message) to a local provider. These types of services have been broadly referred to as “e-visits.”

### SUMMARY

According to an aspect, a computer-implemented method includes receiving, from a brokerage system, a request for a virtual consultation with a service provider, with the requested consultation being one or more of an online consultation or a telephonic consultation; accessing, by a practice management system, a schedule indicative of one or more office appointments of the requested service provider, with the practice management system being remote from the brokerage system; determining, by the practice management system based on the accessed schedule, a time slot in which the requested service provider is available for the requested virtual consultation; and updating, by the practice management system, the schedule with an appointment for the virtual consultation to occur during the determined time slot.

According to an aspect, a computer program product tangibly stored on a computer readable storage device, the computer program product comprising instructions for causing a computer of a practice management system to perform operations comprising: receiving, from a brokerage system, a request for a virtual consultation with a service provider, with the requested consultation being one or more of an online consultation or a telephonic consultation; accessing, by the practice management system, a schedule indicative of one or more office appointments of the requested service provider, with the practice management system being remote from the brokerage system; determining, by the practice management system based on the accessed schedule, a time slot in which the requested service provider is available for the requested virtual consultation; and updating, by the practice management system, the schedule with an appointment for the virtual consultation to occur during the determined time slot.

According to an additional aspect, an apparatus includes a processor of a practice management system, memory in communication with the processor, and a computer program product stored on a computer readable medium, the computer program product comprising instructions for causing the processor to perform operations comprising: receiving, from a brokerage system, a request for a virtual consultation with a service provider, with the requested consultation being one or more of an online consultation or a telephonic consultation; accessing, by the practice management system, a schedule indicative of one or more office appointments of the requested service provider, with the practice management system being remote from the brokerage system; determining, by the practice management system based on the accessed schedule, a time slot in which the requested service provider is available for the requested virtual consultation; and updating, by the practice management system, the schedule with an appointment for the virtual consultation to occur during the determined time slot.

The following are some of the features within the scope of the above aspects. The features include generating a graphical user interface that when rendered on a display device displays: a visual representation of the updated schedule, with a portion of the visual representation depicting the appointment for the virtual consultation, and with another portion of the visual representation depicting the one or more office appointments of the requested service provider. The features also include receiving, from a device used by the requested service provider, information indicative of a selection of the portion of the graphical user interface that depicts the appointment for the virtual consultation; and in response to receiving the information indicative of the section, establishing a communication channel between the device used the requested service provider and a device used by the consumer requesting the virtual consultation.

In some implementations, accessing, by the practice management system, the schedule indicative of the one or more office appointments of the requested service provider comprises: retrieving, by the practice management system, information indicative of a queue, with entries in the queue corresponding to time slots for appointments with the requested service provider, and with at least a portion of the entries being populated with information indicative of scheduled appointments with the requested service provider; wherein determining, based on the accessed schedule, the time slot in which the requested service provider is available for the requested virtual consultation comprises: determining an entry in the queue that is unpopulated with information indicative of a scheduled appointment; and wherein updating the schedule with an appointment for the virtual consultation to occur during the determined time slot comprises: populating the determined entry with information indicative of an appointment between the requested service provider and a consumer requesting the virtual consultation.

The features also include placing information identifying a consumer requesting the virtual consultation in a virtual waiting room; receiving, from a device used by the requested service provider, a request to establish the virtual consultation; establishing a communication channel for the virtual consultation between the device used by the requested service provider and a device used the consumer; and removing from the virtual waiting room the information identifying the consumer requesting the virtual consultation. The features also includes receiving, from a device used by the requested service provider, a request to establish the virtual consultation; and sending a telephone number of the consumer to the device used by the service provider, to have the service provider initiate the call-back between the service provider and a device used by a consumer requesting the virtual consultation.

### BRIEF DESCRIPTION OF THE FIGURES

FIG. 1 is a diagrammatic view of a system for coordinating brokered engagements.

FIG. 2 is a diagram of types of data used in coordinating brokered engagements.

FIGS. 3, 4A and 4B are screenshots of graphical user interfaces.

FIG. 5 is a block diagram of queue structures.

FIG. 6 is a flow chart useful in understanding the system for coordinating brokered engagements.

FIG. 7 is a block diagram of a computer (computer system) showing exemplary components that can be used for the brokerage system and/or client devices.

### DETAILED DESCRIPTION

Overview

The system described below provides an integrated scheduling platform for coordinating brokered engagements (e.g., virtual consultations) with office visits scheduled at a physical location. There are various types of brokered engagements, including, e.g., virtual office visits with a medical service provider (e.g., a physician, a nurse, a physician's assistant, and so forth). Through brokered engagements, consumers are able to consult with a service provider even when the two parties are geographically separated. This integrated platform is referred to herein as a coordinated brokerage engagement system (or depending on the context brokerage service).

Referring now to FIG. 1, an exemplary networked computer system 100 having coordinated brokerage engagement functionality includes a computerized system or server 110 for processing requests (e.g., telephonic requests, network-based requests, Internet based requests, and so forth) from consumers 120 at client systems 122 to engage with providers 130 at provider systems 132. The networked computer system 100 implements a brokerage service for connecting consumers 120 with service providers 130 in engagements (e.g., network-based Internet engagements, telephonic engagements). The networked computer system 100, during brokered engagements, provides information to service providers 130 at client systems 132, over a network 140, e.g., a telephonic network that can be a switched network and/or that can include the Internet (e.g., voice over IP (VOIP)). In some implementations, the networked computer system 100 includes a web server 102 to receive on-line web based requests for the brokered engagements.

The server 110 includes an availability or presence tracking module 112 for tracking the availability of the service providers 130. Availability or presence is tracked actively or passively. In an active system, one or more of the service providers 130 provides an indication to the server 110 that the one or more service providers are available to be contacted by consumers 120 and an indication of the mode by which the provider may be contacted. In some examples of an active system, the provider's computer, phone, or other terminal device periodically provides an indication of the provider's availability (e.g., available, online, idle, busy) to the server 110 and a mode (e.g., text, voice, video, etc.) by which he can be engaged. In a passive system, the server 110 presumes that the service provider 130 is available by the service provider's actions, including connecting to the server 110 or registering the provider's local phone number with the system. In some examples of a passive system, the server 110 indicates the provider 130 to be available at all times until the provider logs off, except when the provider is actively engaged with a consumer 120.

The server 110 also includes one or more processes in addition to the tracking module 112, such as a scheduling module 116. The server 110 accesses one or more databases 118. The components of the server 110 and the web server 102 may be integrated or distributed in various combinations as is commonly known in the art.

The networked computer system 100 allows a consumer 120 to communicate with a provider 130. In some embodiments, such as a telephonic call-back engagement, the server 110 will send to the provider sufficient information to allow the provider to call back the consumer. However, in contrast to known techniques, the server 110 has chosen the provider based on criteria including current availability, as will be discussed below.

In other embodiments, the consumer 120 and provider 130 connect to the server 110 through a telephonic switch or a website or other interface on the web server 102 using client devices 122 and 132, respectively. Client devices 122 and 132 can be any combination of, e.g., personal digital assistants, land-line telephones, cell phones, computer systems, media-player-type devices, and so forth. The client devices 122 and 132 enable the consumers 120 to input and receive information as well as to communicate via video, audio, and/or text with the providers 130.

Limited by office hours and other patients, providers struggle with the idea of adding another service commitment to their existing workload. Patients sending queries to their providers cannot expect an immediate response and are often asked to schedule an appointment for further evaluation. Providers are, however, often available at times that are not convenient for their patients, for example, in the event of a last-minute cancellation. Providers also may be available for e-visits during otherwise idle times; such as when home, during their commute, and so forth. The brokerage supplements existing provider availability to allow whichever providers are available at any given time to call consumers for callback engagements or the other types of engagements mentioned above. Instead of relying on the unlikely availability of a specific provider for any given consumer, the brokerage finds for the consumer currently available providers capable of addressing the consumer's needs.

One advantage that the brokerage provides is that the brokerage constantly monitors the availability of a provider for an engagement. Thus, consumers receive relatively quick attention to address their questions or concerns. When engaging via telephone with call-back, the server 110 forwards the patient connection information to currently available service providers allowing those service providers to call-back the consumer. In order to achieve such a level of availability, the networked computer system 100 assimilates the discretionary or fractional availability windows of time offered by individual providers at stations 132 into a continuous availability perception by consumers. Consumers will have little expectation that the same provider will be constantly available, rather, they expect that some provider will be available.

The server 110 provides information and services to the consumers 120 in addition to providing connection information to service providers 130. The server 110 includes an access control facility 114 that manages and controls whether a particular consumer 120 can access the networked computer system 100 and what level or scope of access to the features, functions, and services the networked computer system 100 will provide.

The consumer 120 uses the networked computer system 100 to find out more information about a topic of interest or, for example, a potential medical condition. The server 110 identifies service providers 130 that are available at any given moment to communicate with a consumer about a particular product, service, or related topic or subject, for example, a medical condition. The server 110 facilitates establishment of communication directly by provider 130 with the consumer 120, enabling them to communicate, for example, via telephonic or video or voice communication channel (such as Voice over IP), land and mobile telephone network channels, and instant messaging or chat.

The availability of one or more providers 130 is tracked. In callback examples, when a consumer 120 desires communicate with a provider, a request is processed through intake and the server 110 determines a currently available provider for a call back.

In non-callback examples, at the instant a consumer 120 desires to connect and communicate with a provider, the server 110 determines whether that provider is available. If that particular provider 130 is available, the server 110 assesses the various modes of communication that are available and forwards connection information of the consumer 120 to the service provider 130 through one or more common modes of communication. The system selects a mode of communication to use based in part on the relative utility of the various modes.

A mode for a non-callback engagement has both the consumer 120 and the provider 130 use web-based consoles, as this allows each of the other modes to be used as needed. For example, consumers and providers may launch chat sessions, voice calls, or video chats from within a web-based console. A web based console also provides on-demand access to records, such as the consumer's medical history, and other information. If only one of the participants in an engagement has access to a web console, the server 110 connects that participant's console to whatever form of communication the other party has available. For example, if the consumer is on the phone and the provider is using a web browser, the server 110 may connect the consumer's phone call to a VoIP session that the provider can access through the web. If the provider 130 is not available, the server 110 identifies other available providers 130 that would meet the consumer's needs. The server 110 enables the consumer 120 to send a message to the consumer's chosen provider.

By way of illustration, the networked computer system 100 services patients that are members of healthcare plans. For example, the service providers 130 may be physicians, and the service consumers 120 may be patients. The service providers and service consumers may also be lawyers and clients, contractors and homeowners, or any other combination of a provider of services and a consumer of services.

The system enables the consumer to search for providers that are available at the time the consumer is searching, and enables the consumer to engage a provider on a transactional basis or for a one-time consultation. A consumer can use the system for various purposes, such as a consultation or second opinion.

Many of the web-based functions are also provided by an Interactive Voice Response (IVR) system, as discussed in U.S. Pat. No. 7,590,550 entitled: “Connecting Consumers with Service Providers”, the contents of which are incorporated herein in its entirety. As noted, a consumer can access the IVR system via a telephone and the server 110 parses responses into a formulation of the consumer's inquiry either by keypad entries or speech recognition technologies.

System 100 also includes practice management system 142, which is a system that is external to brokerage system 110. Practice management system 142 executes various operations for scheduling appointments with service providers, including, e.g., appointments at physical locations (e.g., a physician's physical office). Practice management system 142 communicates with databases 140. Databases 140 store schedule 136, which is a schedule of appointments of a particular service provider (or a group of service providers) associated with a particular geographic location (e.g., associated with a particular medical office).

Administrators of a medical office use practice management system 142 to maintain and to update a schedule of a service provider. For example, when a patient calls into a doctor's office for an appointment, an administrator uses practice management system 142 to access schedule 136 of the doctor and to enter into the schedule 136 a new appointment for the patient.

In one implementation, practice management system 142 is physically located within a physical location associated with a service provider (e.g., within a doctor's office). In another implementation, practice management system 142 is located remote from the physical location associated with the service provider. In this implementation, practice management system 142 includes a web interface for enabling administrators and/or service providers (associated with a particular office) to access and to view a schedule of a service provider associated with the office.

Practice management system 142 executes integration engine 134. Integration engine 134 communicates with brokerage system 110, to enable coordination among appointments for consultations occurring at physical locations and appointments for virtual consultations, e.g., brokered engagements. In an implementation, brokerage system 110 transmits integration engine 134 (and/or information for integration engine 134) to practice management system 142, to enable practice management system 142 to download integration engine 134 from brokerage system 110.

Through integration engine 134, practice management system 142 receives coordination information indicative of requests for brokered engagements (e.g., online consultations) with service providers. Responsive to receipt of the coordination information, practice management system 142 accesses a schedule associated with a service provider specified in the coordination information. Using contents of the coordination information practice management system 142 updates a schedule of the specified service provider with an appointment for the brokered engagement, as described in further detail below.

Consumer 120 sends, to brokerage system 110, a request 150 for an appointment for a brokered engagement with a service provider associated with specified attributes. Request 150 includes one or more of information specifying a time and a date of the requested brokered engagement. In response to the request 150, brokerage system 110 identifies that service provider 130 is associated with attributes that at least partly match one or more of the requested attributes. Brokerage system 110 accesses, in database 118, a record (not shown) associated with service provider 130. The record specifies that service provider 130 is enrolled in coordinated brokered engagements via practice management system 142. The record also includes information specifying communication information (e.g., an IP address) for practice management system 142.

Upon detecting that service provider 130 is enrolled in coordinated brokered engagements via practice management system 142, brokerage system 110 generates coordination information 160, based on the contents of the request 150 from consumer 120 for the brokered engagement and based on information included in the record of service provider 130.

Referring now to FIG. 2, coordination information 160 includes one or more of practice name information 162, service provider name information 164, requested date information 165, preferred time information 166, consumer name information 168, and communication mode information 170. Practice name information 162 includes information specifying a name of a provider practice (e.g., an office name) associated with service provider 130. Brokerage system 110 obtains practice name information 162 from the record of service provider 130.

Service provider name information 164 includes information specifying a name of service provider 130. Requested date information 165 includes information specifying a date of the requested brokered engagement, as specified in request 150. Preferred time information 166 includes information specifying a time of the requested brokered engagement, as specified in request 150. Consumer name information 168 includes information specifying a name of consumer 120, as specified in request 150. Communication mode information 170 includes information specifying a requested mode of communication for the brokered engagement, as specified in request 150. As described above, there are various types of communication modes, including, a voice-based communication mode, a text-based communication mode, a video-based communication mode, and so forth. Communication mode information 170 is based on one or more of a requested type of communication mode (specified in request 150), communication capabilities of client devices 122, 132, types of communications modes that service provider 130 has specified as being available for engagements.

Referring back to FIG. 1, brokerage system 110 transmits coordination information 160 to practice management system 142, e.g., using the communication information for practice management system 142. Integration engine 134 receives coordination information 160. Integration engine 134 parses coordination information 160 to identify the service provider for which the coordinated brokered engagement is requested. Using service provider name information 164 (FIG. 2), integration engine 134 determines that a coordinated brokered engagement is requested for service provider 130.

Databases 140 store schedules (e.g., schedule 136) for service providers in association with service provider name information and/or in association with practice name information. In one implementation, a provider practice includes a plurality of different service providers. In this example, the schedules for the plurality of different service providers are stored in a hierarchy in databases 140, with the schedules being associated with provider practice information at an upper level of the hierarchy and with the schedules being associated with provider name information at the lower levels of the hierarchy. Using service provider name information 164 (FIG. 2), integration engine 134 determines that schedule 136 is associated with service provider 130. Using requested date information 165, integration engine 134 identifies a portion of schedule 136 that pertains to the requested date for the brokered engagement.

Referring now to FIG. 3, graphical user interface 180 displays the portion of schedule 136 that pertains to the requested date for the brokered engagement. On the requested date, service provider 130 has three scheduled appointments, as specified by information 182, 184, 186 (which may hereinafter be referred to as appointments 182, 184, 186, for purposes of convenience, and without limitation). The appointments specified by information 182, 184 are appointments that are scheduled to occur at an office of service provider 130. The appointment specified by information 186 is for a virtual consultation that is either brokered by brokerage system 110 or is initiated by service provider 130 via client device 132.

A virtual consultation is brokered by brokerage system 110 when brokerage system 110 establishes as communication channel between client devices 122, 132 for the engagement. Alternatively, service provider 130 may directly contact consumer 120 for a virtual consultation by using client device 132 to initiate a telephone call to client device 122. Brokerage system 110 passes to practice management system 142 contact information for consumer 120 (e.g., a telephone number associated with client device 122) that is used by service provider 130 in contacting consumer 120. Graphical user interface 180 also displays information 188, 190, 200, 202, 204, 206, 208, 210, 212, 214, 216 indicative of one or more open time slots in the schedule of service provider 130 on the requested date for the brokered engagement. Information 188, 190, 200, 202, 204, 206, 208, 210, 212, 214, 216 may be referred to herein as available appointments 188, 190, 200, 202, 204, 206, 208, 210, 212, 214, 216, for purposes of convenience, and without limitation.

Referring back to FIG. 1, integration engine 134 uses coordination information 160 to coordinate the request 150 for the brokered engagement with appointments 182, 184, 186 (FIG. 3) included in schedule 136. Integration engine 134 determines whether one of available appointments 188, 190, 200, 202, 204, 206, 208, 210, 212, 214, 216 is associated with a time that matches the time specified in preferred time information 166 (FIG. 2). If integration engine 134 determines that one of available appointments 188, 190, 200, 202, 204, 206, 208, 210, 212, 214, 216 is associated with a time that matches the time specified in preferred time information 166, integration engine 134 schedules the requested brokered engagement to occur during the determined available appointment. In one implementation, integration engine 134 updates the portion of schedule 136 that pertains to the requested date and requested time for the brokered engagement with an appointment for the requested engagement. By updating schedule 136 with the appointment for the requested brokered engagement, integration engine 134 generates integrated schedule 138, which is a schedule that coordinates appointments for in-person engagements occurring at physical locations with appointments for virtual consultations, e.g., brokered engagements.

If integration engine 134 determines that none of available appointments 188, 190, 200, 202, 204, 206, 208, 210, 212, 214, 216 is associated with a time that matches the time specified in preferred time information 166, integration engine 134 selects an available appointment with an associated time that is closest to the request time. In another implementation, a consumer specifies a date for the requested appointment, but does not specify a requested time. Integration engine 134 schedules an appointment for the consumer to occur at a first available time on the requested day.

As noted, the server 110 includes access control facilities 114 that control how consumers 120 access the system and to what extent or level the services provided by the system are made available to consumers. The server 110 also stores and provides access to consumer information (e.g., contact information, credit and financial information, credit card information, health information, and other information related to the consumer and the services purchased or otherwise used by the consumer) and provider information (e.g., physician biographies, product and service information, health related content and information and any information the provider or the health plan wants to make available to members) and the access control facility 114 can prevent unauthorized access to this information. In some examples, the server 110 exports the consumer information for use in a provider's office or other facility.

In some implementations of the networked computer system 100 consumers access the either on-line and/or through the telephonic engagements discussed above. In other implementations, of the brokerage system 100 access is only through telephonic engagements. In this later instance, the queue structures can be greatly simplified. Several types of engagements may exist, e.g., “consumer-initiated engagements” “follow-up engagements” and “prescheduled engagements” and “standby engagements.”

In some embodiments, consumers may select providers according to attributes of the provider, such as a geographical area where the provider is located or which professional organizations have accredited the provider (e.g., whether a doctor has board certification in cardiology). Any metrics within the provider profile can be used to define a list of providers that meet the consumer's preferences. In this case, the system will use the consumer's selection to override the least used scheme for populating provider queues.

Modes of Engagement

Telephonic callbacks—Consumers who wish for a telephonic consultation with a provider may use a traditional telephone to enter information, as discussed above, and hangs up and waits for a call-back from a suitable provider, as also discussed above. Providers are sent information concerning the consumer in order to understand the consumer's issue and a telephone number by which the provider contacts the consumer.

In some embodiments of the networked computer system 100, the networked computer system 100 allows consumers to engage provider's e.g., health professionals “on demand” based on provider availability. These engagements can be established in various ways as described in the above mentioned patent. These types of engagements include:

Passive browsing—Reference health content is accessed on the brokerage's website. The website can support the use of licensed content packages from other vendors to meet the variable preferences of health plans. For example, key content vendors include Healthwise™, ADAM™, Mayo Clinic™ and HealthDay™. Content libraries provided by such vendors offer a combination of articles, imagery, interactive tutorials and related tools that allow consumers to access content relevant for their health issues. Many health plans and major employers already possess a license for the use of one of these content packages.

Health Risk Assessments—The system acquires information from consumers through automated interaction (e.g., rules-based interaction) in order to crystallize their needs (e.g., medical risks) and better direct them. Assessments span from general health to very specific medical conditions and follow a path of questioning that dynamically tailors itself based on information already retrieved (e.g., using predefined rules). As assessments progress, the system constructs engagement suggestions that the consumer can exercise. Each suggestion represents both the question to the provider and the type of provider appropriate to answer it. Consumers may choose to simply launch such engagements or apply their own discretion as to the phrasing and the selection of the recipient provider. This is discussed in more detail below in the context of the consumer advisor.

Asynchronous correspondence—The lowest level of true provider interaction is by way of secure messaging. The question or topic of the engagement is sent to a selected provider (whether online or not) and can be answered by this provider at her leisure. Turnaround times are monitored by the system and are part of the credentials of the provider used for her selection by consumers. The system informs the consumer once a response has been received and can allow the consumer to redirect the question if he needs more urgent response time. For example, typical types of asynchronous correspondence include e-mail, instant messaging, text-messaging, voice mail messaging, VoIP messaging (i.e., leaving a message using VoIP), and paper letters (e.g., via the U.S. Postal Service).

Synchronous correspondence—Several forms of synchronous correspondence allow the consumer and the provider to engage in real-time discussions.

Synchronous text correspondence—This may be referred to as a “Chat” module where both sides of the engagement type their entries in response to each others' entries. The form of communication may be entirely text based but is still a live communication. Examples include instant messaging and SMS messaging.

Web-based teleconferencing—The use of broadband network connections allows for real-time voice transmission over the Internet in what is referred to as full duplex (i.e., both voice channels are open at the same time). Consumers can opt to have a voice conversation with their providers using, for example, their computer's speakers and microphone. Web-based teleconferencing may use VoIP, SIP, and other standard or proprietary technologies.

Telephonic conferencing—Consumers who wish for a direct telephonic communication with a provider or who are not comfortable using their computer may use a traditional telephone for interaction with a provider. The consumer may use a dial-in number and an access code that connects him to the brokerage's servers. Providers are linked to the servers via VoIP, other data-network-based voice systems, or their own telephones. Telephonic conferencing may also allow consumers to request “call me now” functions, in which the provider calls the consumer (directly or through the brokerage).

Video conferencing—The system can support video conferencing to allow consumers to exhibit physical findings to providers if such disclosure is needed. Consumers and providers may also simply prefer face-to-face communication, even if remote. Small digital cameras, referred to as webcams, attached to or built in to personal computers or laptops can be used for this purpose. Video conferencing can be provided by standard software or by custom software provided by the brokerage. Alternatively, dedicated video conferencing communication equipment or telephones with built-in video capabilities can be used.

Semi synchronous correspondence—Some engagements of a consumer with an online provider include both synchronous and asynchronous interactions. Part of the engagement takes place by immediate messaging between the two, but the provider may ask the consumer to take occasional asynchronous assessments if, for example, a generic line of question is desired. This allows the provider to operate more than one consumer engagement at a time while each consumer is constantly engaged. For example, semi-synchronous correspondence includes a combination of e-mail, instant messaging, test messaging, voice calls and mail messaging, and VoIP calls and VoIP messaging.

Referring to FIG. 4A, graphical user interface 230 displays contents of an integrated scheduled for a service provider. Practice management system 142 generates data for graphical user interface 230 and transmits the generated data to client device 132 (or to another device associated with a physical location of a service provider). Client device 132 renders the transmitted data to display graphical user interface 230 (e.g., via web interface).

Graphical user interface 230 displays a “daily schedule” for a service provider. Graphical user interface 230 displays queue 232, which is indicative of a schedule of appointments of consumers for a consultation with a service provider. Population of queue 232 is displayed in further detail below.

Graphical user interface 230 includes portion 234 for entry of a name of a service provider and control 235. Upon selection of control 235, graphical user interface 230 is updated with an integrated schedule for the service provider specified in portion 234.

Graphical user interface 230 also includes portion 236 for input of information specifying a date of a schedule to be displayed in graphical user interface 230. Based on the information input into portions 234, 236, graphical user interface 230 is updated with a schedule for a service provider specified in portion 234 on a date specified in portion 236.

Graphical user interface 230 also includes portion 238 specifying a location of a consumer who is waiting for a consultation with the service provider and/or who has an appointment scheduled with the service provider. There are various types of locations, including, e.g., a virtual waiting room and a physical waiting room. Generally, a virtual waiting room is an online queue in which information indicative of a consumer is placed, e.g., until a service provider is available to engage in a consultation with the consumer. A physical waiting room is a room in an office of a service provider that is designated for patients to wait in, e.g., until a service provider is available for the office visit.

Graphical user interface 230 also includes portion 240 for display of information specifying a status associated with a consumer who has an appointment scheduled with a service providers. There are various types of statuses, e.g., a status that a service provider (e.g., a nurse) is available to see a consumer. Graphical user interface 230 also includes portion 242 for display of information indicative of a time of an appointment of a consumer. Graphical user interface 230 includes portion 244 for display of information indicative of a name of a consumer with a scheduled appointment with a service provider. Graphical user interface 230 includes portion 246 for display of information indicative of a type of appointment a consumer has scheduled with a service provider. There are various type of appointments, including, appointments for a virtual consultations, appointments for in-office visits (e.g., consultations at a physical office of a service provider), and so forth.

Graphical user interface 230 also includes portion 248 for display of information indicative of duration of a scheduled appointment. Graphical user interface 230 includes portion 250 for display of information specifying an appointment number associated with a scheduled appointment for a consumer. An appointment number is a unique number that is associated with a scheduled appointment. Graphical user interface 230 includes portion 252 for display of information specifying task codes associated with a scheduled appointment. A task code specifies one or more procedures or operations to be performed during an appointment. In an implementation, an administrator who is using practice management system 142 enters in task codes when scheduling an appointment. Graphical user interface 230 also includes portion 254 for display of information indicative of comments that are associated with a medical condition of a consumer. Through information displayed in portion 254, a service provider is able to ascertain the reason for the consumer's appointment. When a service provider becomes available to engage with a consumer in queue 232, the service provider (and/or an administrator) selects a portion of graphical user interface 230 that is associated with the consumer and selects a queue control (not shown) in graphical user interface 230 to take the patient out of the queue and to cause graphical user interface 230 to be updated through removal of information indicative of the selected patient.

Referring now to FIG. 4B, brokerage system 110 generates graphical user interface 260 for display of an integrated schedule 261. The integrated schedule 261 displays representations of scheduled appointments at physical locations (e.g., office visits), representations of scheduled appointments for online engagements, representations of consumers who are waiting for a first available appointment (e.g., in-office visit) with a service provider and representations of consumers who are waiting for a first available online engagement with a service provider.

Graphical user interface 260 includes portion 262 for display of information indicative a consumer who is first in a queue for consultations with a service provider. Portion 262 displays icon 262e to represent a type of appointment that is represented in portion 262. Icon 262e indicates that the appointment is an in-office visit.

Portion 262 also displays information indicative of a name of the consumer who is first in the queue and information indicative of an amount of time that the consumer has been waiting for the appointment. Portion 262 also displays control 262a, selection of which sends to brokerage system 110 information indicating that the service provider will “attend” the appointment with the consumer. Upon selection of control 262a, the brokerage system 110 updates integrated schedule 261 by removing (not shown) portion 262 from integrated schedule 261, which in turn causes removal of the consumer represented in portion 262 from the queue of consumers waiting for consultations with the service provider.

Portion 262 also includes control 262b, selection of which removes portion 262 from integrated schedule 261, which in turn causes removal of the consumer represented in portion 262 from the queue of consumers waiting for consultations with the service provider. Control 262b specifies removal, from integrated schedule 261, of the consumer represented in portion 262. Portion 262 also includes control 262c, selection of which causes brokerage system 110 to display, for a service provider, a medical record of the consumer represented in portion 262.

Graphical user interface 260 includes portion 263 for display of information indicative a consumer who waiting in a queue represented by integrated schedule 261 for consultations with a service provider. Portion 263 displays icon 263e to represent a type of appointment that is represented in portion 263. Icon 263e indicates that the consumer is waiting on a “first-come-basis” for a telephonic engagement with the service provider.

Portion 263 also displays information indicative of a name of the consumer who is waiting for the telephonic engagement and information indicative of an amount of time that the consumer has been waiting for the telephonic engagement. Portion 263 also displays control 263a, selection of which sends to brokerage system 110 information indicating that the service provider is requesting establishment of a communication channel between a telephonic device used by the service provider and a telephonic device used by the consumer. Upon selection of control 263a, the brokerage system 110 updates integrated schedule 261 by removing portion 263 from integrated schedule 261, which in turn causes removal of the consumer represented in portion 263 from the queue of consumers waiting for consultations with the service provider.

Portion 263 also include control 263b, selection of which removes portion 263 from integrated schedule 261, which in turn causes removal of the consumer represented in portion 263 from the queue of consumers waiting for consultations with the service provider. Control 263b specifies removal, from integrated schedule 261, of the consumer represented in portion 263. Portion 263 also includes control 263c, selection of which causes brokerage system 110 to display, for a service provider, a medical record of the consumer represented in portion 263. In a variation of FIG. 4B, practice management system 142 generates integrated schedule 261, e.g., based on the contents of schedule 136 and based on coordination information 160 received from brokerage system 110.

Referring now to FIG. 5, brokerage system 110 (FIG. 1) transfers coordination information 160 to integration engine 134. The integration engine 134 uses coordination information 160 to schedule appointments with providers for consumers. In one scheduling algorithm, each provider is associated with a queue, e.g., 270a-270n. A queue represents a schedule of a service provider (e.g., schedule 136 in FIG. 1). The queue for each provider is filled by integration engine 134 with entries (as depicted as entries n and entries m) that appointments (e.g., appointments for office visits, appointments for virtual consultations, and so forth) with a provider at a particular time. An entry in the queue is associated with a time slot, specifying a time of the appointment. More specifically, as consumers use brokerage system 110 to request brokered engagements and use practice management system 142 to schedule appointments for office visits that are processed through an intake process of, entries representing appointments of the consumers are produced by practice management system 142 and/or by integration engine 124 and those entries are queued.

Upon receiving coordination information 160 and a request to schedule an appointment with a particular provider, integration engine 134 identifies an entry in a queue (e.g., one of queues 270a-270n) of a service provider, with the identified entry being representing an available appointment at a time that matches a requested time and/or that is close to a requested time. Integration engine 134 populates the identified entry with information associated with the consumer (e.g., a name of the consumer, a reason for the appointment, information specifying whether the appointment is for an office visit or a virtual consultation, and so forth). As the provider services that consumer, integration engine 134 removes the corresponding entry from that provider's queue and then the integration engine 134 promotes all remaining entries in that queue such that the next entry in the queue to be serviced will be now be the oldest entry. Integration engine 134 integrates brokered engagements with in-office visits by populating queues 270a-270n with entries that represent both brokered engagements and in-office visits.

Referring to FIG. 6, integration engine 134 implements process 280 in coordinating brokered engagements. In operation, integration engine 134 receives (282), from brokerage system 110, a request to coordinate an appointment for a brokered engagement with a particular service provider with other appointments in a schedule of a service provider. The request includes coordination information 160 (FIG. 1). In response to receipt of the request with the coordination information 160, integration engine 134 accesses (284) a schedule (e.g., schedule 136) of the particular service provider. Using the accessed schedule, integration engine 134 identifies (286) an available appointment in the schedule of the available service provider. When the request for coordination includes a preferred time for the appointment, integration engine 134 determines if there is an available appointment at the preferred time in the accessed schedule. When there is an available appointment at the preferred time, integration engine 134 updates (288) the accessed schedule with an appointment for the brokered engagement to occur at the preferred time. Integration engine 134 updates the schedule through insertion, into a queue representing a schedule of the service provider, of an entry that represents the appointment. The entry is inserted into the queue in accordance with a time associated with the entry and to promote a time-based ordering of entries in the queue.

When the request for coordination includes a request for a first available appointment with a particular provider, integration engine 134 identifies in a schedule of the service a first available appointment (e.g., a first available appointment at an earliest date). Integration engine 134 updates the schedule of the service provider by inserting into the schedule an appointment for the brokered engagement at the first available time slot. Following updating of the schedule with the appointment for the brokered engagement, practice management system 142 (and/or integration engine 134) generates (290) a graphical user interface (e.g., graphical user interface 230) for display of the updated schedule.

FIG. 7 is a block diagram of components 300 of the engagement brokerage system. User devices 302 can be any sort of computing device capable of taking input from a user and communicating over a network (not shown) with server 110 and/or with other client devices. For example, user device 302 can be a mobile device, a desktop computer, a laptop, a cell phone, a personal digital assistant (“PDA”), a server, an embedded computing system, a mobile device and so forth. User devices 302 include monitor 304 which render visual representations of interface 306.

Server 110 can be any of a variety of computing devices capable of receiving information, such as a server, a distributed computing system, a desktop computer, a laptop, a cell phone, a rack-mounted server, and so forth. Server 110 may be a single server or a group of servers that are at a same location or at different locations.

Server 110 can receive information from client device 302 via interfaces 306, including, e.g., graphical user interfaces. Interfaces 306 can be any type of interface capable of receiving information over a network, such as an Ethernet interface, a wireless networking interface, a fiber-optic networking interface, a modem, and so forth. Server 110 also includes a processor 308 and memory 310. A bus system (not shown), including, for example, a data bus and a motherboard, can be used to establish and to control data communication between the components of server 110.

Processor 308 may include one or more microprocessors. Generally, processor 308 may include any appropriate processor and/or logic that is capable of receiving and storing data, and of communicating over a network (not shown). Memory 310 can include a hard drive and a random access memory storage device, such as a dynamic random access memory, machine-readable media, or other types of non-transitory machine-readable storage devices.

Components 300 also include storage device 312, which is configured to store information collected through the brokerage system during a service provider's consultation with a consumer.

Embodiments can be implemented in digital electronic circuitry, or in computer hardware, firmware, software, or in combinations thereof. Apparatus of the invention can be implemented in a computer program product tangibly embodied or stored in a machine-readable storage device for execution by a programmable processor; and method actions can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Other embodiments are within the scope and spirit of the description claims. For example, due to the nature of software, functions described above can be implemented using software, hardware, firmware, hardwiring, or combinations of any of these. Features implementing functions may also be physically located at various positions, including being distributed such that portions of functions are implemented at different physical locations.

What is claimed is:

1. A computer-implemented method comprising:
receiving, from a brokerage system, a request for a virtual consultation with a service provider, with the requested consultation being one or more of an online consultation or a telephonic consultation;
accessing, by a practice management system, a schedule indicative of one or more office appointments of the requested service provider, with the practice management system being remote from the brokerage system;
determining, by the practice management system based on the accessed schedule, a time slot in which the requested service provider is available for the requested virtual consultation; and
updating, by the practice management system, the schedule with an appointment for the virtual consultation to occur during the determined time slot.

2. The method of claim 1 further comprising:
generating a graphical user interface that when rendered on a display device displays:
a visual representation of the updated schedule, with a portion of the visual representation depicting the appointment for the virtual consultation, and with another portion of the visual representation depicting the one or more office appointments of the requested service provider.

3. The method of claim 2, further comprising:
receiving, from a device used by the requested service provider, information indicative of a selection of the portion of the graphical user interface that depicts the appointment for the virtual consultation; and
in response to receiving the information indicative of the section, establishing a communication channel between the device used the requested service provider and a device used by the consumer requesting the virtual consultation.

4. The method of claim 1, wherein accessing, by the practice management system, the schedule indicative of the one or more office appointments of the requested service provider comprises:
retrieving, by the practice management system, information indicative of a queue, with entries in the queue corresponding to time slots for appointments with the requested service provider, and with at least a portion of the entries being populated with information indicative of scheduled appointments with the requested service provider;
wherein determining, based on the accessed schedule, the time slot in which the requested service provider is available for the requested virtual consultation comprises:
determining an entry in the queue that is unpopulated with information indicative of a scheduled appointment; and
wherein updating the schedule with an appointment for the virtual consultation to occur during the determined time slot comprises:
populating the determined entry with information indicative of an appointment between the requested service provider and a consumer requesting the virtual consultation.

5. The method of claim 1, further comprising:
placing information identifying a consumer requesting the virtual consultation in a virtual waiting room;
receiving, from a device used by the requested service provider, a request to establish the virtual consultation;
establishing a communication channel for the virtual consultation between the device used by the requested service provider and a device used the consumer; and
removing from the virtual waiting room the information identifying the consumer requesting the virtual consultation.

6. The method of claim 1, further comprising:
receiving, from a device used by the requested service provider, a request to establish the virtual consultation; and
sending a telephone number of the consumer to the device used by the service provider, to have the service provider initiate the call-back between the service provider and a device used by a consumer requesting the virtual consultation.

7. A computer program product tangibly stored on a computer readable storage device, the computer program product comprising instructions for causing a computer of a practice management system to perform operations comprising:
receiving, from a brokerage system, a request for a virtual consultation with a service provider, with the requested consultation being one or more of an online consultation or a telephonic consultation;
accessing, by the practice management system, a schedule indicative of one or more office appointments of the requested service provider, with the practice management system being remote from the brokerage system;
determining, by the practice management system based on the accessed schedule, a time slot in which the requested service provider is available for the requested virtual consultation; and
updating, by the practice management system, the schedule with an appointment for the virtual consultation to occur during the determined time slot.

8. The computer program product of claim 7, wherein the operations further comprise:
generating a graphical user interface that when rendered on a display device displays:
a visual representation of the updated schedule, with a portion of the visual representation depicting the appointment for the virtual consultation, and with another portion of the visual representation depicting the one or more office appointments of the requested service provider.

9. The computer program product of claim 8, wherein the operations further comprise:
receiving, from a device used by the requested service provider, information indicative of a selection of the portion of the graphical user interface that depicts the appointment for the virtual consultation; and
in response to receiving the information indicative of the section, establishing a communication channel between the device used the requested service provider and a device used by the consumer requesting the virtual consultation.

10. The computer program product of claim 7, wherein accessing, by the practice management system, the schedule indicative of the one or more office appointments of the requested service provider comprises:
retrieving, by the practice management system, information indicative of a queue, with entries in the queue corresponding to time slots for appointments with the requested service provider, and with at least a portion of the entries being populated with information indicative of scheduled appointments with the requested service provider;
wherein determining, based on the accessed schedule, the time slot in which the requested service provider is available for the requested virtual consultation comprises:
determining an entry in the queue that is unpopulated with information indicative of a scheduled appointment; and
wherein updating the schedule with an appointment for the virtual consultation to occur during the determined time slot comprises:
populating the determined entry with information indicative of an appointment between the requested service provider and a consumer requesting the virtual consultation.

11. The computer program product of claim 7, wherein the operations further comprise:
placing information identifying a consumer requesting the virtual consultation in a virtual waiting room;
receiving, from a device used by the requested service provider, a request to establish the virtual consultation;
establishing a communication channel for the virtual consultation between the device used by the requested service provider and a device used the consumer; and
removing from the virtual waiting room the information identifying the consumer requesting the virtual consultation.

12. The computer program product of claim 7, wherein the operations further comprise:
receiving, from a device used by the requested service provider, a request to establish the virtual consultation; and
sending a telephone number of the consumer to the device used by the service provider, to have the service provider initiate the call-back between the service provider and a device used by a consumer requesting the virtual consultation.

13. An apparatus comprising:
a processor of a practice management system;
memory in communication with the processor; and
a computer program product stored on a computer readable medium, the computer program product comprising instructions for causing the processor to perform operations comprising:
receiving, from a brokerage system, a request for a virtual consultation with a service provider, with the requested consultation being one or more of an online consultation or a telephonic consultation;
accessing, by the practice management system, a schedule indicative of one or more office appointments of the requested service provider, with the practice management system being remote from the brokerage system;
determining, by the practice management system based on the accessed schedule, a time slot in which the requested service provider is available for the requested virtual consultation; and
updating, by the practice management system, the schedule with an appointment for the virtual consultation to occur during the determined time slot.

14. The apparatus of claim 13, wherein the operations further comprise:
generating a graphical user interface that when rendered on a display device displays:
a visual representation of the updated schedule, with a portion of the visual representation depicting the appointment for the virtual consultation, and with another portion of the visual representation depicting the one or more office appointments of the requested service provider.

15. The apparatus of claim 14, wherein the operations further comprise:
receiving, from a device used by the requested service provider, information indicative of a selection of the portion of the graphical user interface that depicts the appointment for the virtual consultation; and
in response to receiving the information indicative of the section, establishing a communication channel between the device used the requested service provider and a device used by the consumer requesting the virtual consultation.

16. The apparatus of claim 14, wherein accessing, by the practice management system, the schedule indicative of the one or more office appointments of the requested service provider comprises:
retrieving, by the practice management system, information indicative of a queue, with entries in the queue corresponding to time slots for appointments with the requested service provider, and with at least a portion of the entries being populated with information indicative of scheduled appointments with the requested service provider;
wherein determining, based on the accessed schedule, the time slot in which the requested service provider is available for the requested virtual consultation comprises:
determining an entry in the queue that is unpopulated with information indicative of a scheduled appointment; and
wherein updating the schedule with an appointment for the virtual consultation to occur during the determined time slot comprises:
populating the determined entry with information indicative of an appointment between the requested service provider and a consumer requesting the virtual consultation.

17. The apparatus of claim 14, wherein the operations further comprise:
placing information identifying a consumer requesting the virtual consultation in a virtual waiting room;
receiving, from a device used by the requested service provider, a request to establish the virtual consultation;
establishing a communication channel for the virtual consultation between the device used by the requested service provider and a device used the consumer; and
removing from the virtual waiting room the information identifying the consumer requesting the virtual consultation.

18. The apparatus of claim 14, wherein the operations further comprise:
receiving, from a device used by the requested service provider, a request to establish the virtual consultation; and
sending a telephone number of the consumer to the device used by the service provider, to have the service provider initiate the call-back between the service provider and a device used by a consumer requesting the virtual consultation.
